(19) United States
(12) Patent Application Publication
(10) Pub. No.: US 2012/0218893 A1
(43) Pub. Date: Aug. 30, 2012

(54) METHOD AND APPARATUS FOR ANALYZING A NETWORK

(76) Inventors: Srikanth Natarajan, Fort Collins, CO (US); Banerjee Swapnesh, Bangalore (IN); Bhaltacharya Samik, Bangalore (IN)

(21) Appl. No.: 13/035,355

(22) Filed: Feb. 25, 2011

(51) Int. Cl. H04L 12/26

(52) U.S. Cl. 370/235

(57) ABSTRACT

In a method analyzing a network, packet flow information of a virtual local area network (VLAN) implemented in the network is received. The packet flow information is sent from a node in the network and includes a VLAN identification (ID) of the VLAN. A representation of the VLAN is identified in a network topology based on the node and the VLAN ID of the VLAN. The packet flow information is associated with the representation of the VLAN.

### BACKGROUND

Ethernet switching technology provides high bandwidth, low latency, and scalability for large datacenters and computers for data communication. A number of approaches have been used to exploit multiple paths in an Ethernet. For example, the network can be partitioned using layer-three Internet Protocol (IP) subnets or layer-two Virtual Local Area Networks (VLANs). Although these approaches limit the scope of flat layer two networks and assist in exploiting multiple paths, complex and costly manual administration are still required.

Communications network operators need efficient reporting applications to analyze the data generated from the network elements. The data may be traffic, fault or performance data. With the increase of subscribers and services in telecommunications, the volume of data generated has also grown significantly. As a result, the data as become increasingly difficult to handle and analyze efficiently. In addition to the scale of the data, the data itself is typically more complex and include noise elements. Handling and storing such data involves large amounts of costly processing power and storage.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a network, according to an example of the present disclosure;

FIG. 2 shows a diagram of a user interface for a network analysis manager, according to an example of the present disclosure;

FIG. 3 shows a diagram of a user interface for a master collector, according to an example of the present disclosure;

FIG. 4 depicts a flow diagram of a method for analyzing a network, according to another example of the present disclosure; and

FIG. 5 illustrates a computer system, which may be employed to perform various functions described herein, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are a method, apparatus, and system for analyzing a network. In the method, packet flow information of a virtual local area network (VLAN) implemented in the network is received. The packet flow information is sent from a node, such as a router, in the network and includes a VLAN identification (ID) of the VLAN. A representation of the VLAN is identified in a network topology based on the node and the VLAN ID of the VLAN. The packet flow information is associated with the representation of the VLAN.

As discussed herein, a packet may be a data packet and a stream of data packets carries information needed for communication flows that transport information streams over a network between sending and receiving devices. Examples of types of packet streams are multiplayer game data, streaming video or audio, or bulk transfer of data. The source and destination devices are configured to send or receive packets via a route in a network and packets may pass through the route to the destination device through the network or through another network.

Through implementation of the method, apparatus, and system disclosed herein, the topology of a network and VLANs implemented in the network, including participating switches in the VLAN, may be linked with packet flow information flowing over the network. As discussed in greater detail below, packet flow information is a directed stream of Internet Protocol (IP) flow packet data including information regarding the packet that may be sent from a designated router(s) to a collection/analysis software. The packet flow information may be categorized by application, which provides an integrated view of the configured VLANs from both the topology and traffic load perspectives. In addition, the network and VLAN topologies may be linked to application traffic analysis. Moreover, a VLAN management tool is disclosed herein, which allows for inspection and identification of bottlenecks in a current VLAN setup. Through analysis of application traffic flowing between VLANs, troubleshooting of bandwidth and network congestion related issues may be streamlined for improved performance.

Traffic analysis and application categorization at the router interface level are currently being performed. While this approach provides a view of the traffic in the network in terms of consumers and producers, it does not provide VLAN based analysis, as this approach lacks the capability to discover and link VLANs to traffic data. Also the VLAN Id is reported at the router level, while VLAN operation happens at the switch port level. The method, apparatus, and system for analyzing a network dsiclosed herein provide a connection between the application traffic and participating VLANs, which provides relatively more accurate inter-VLAN traffic characterization and analysis as compared with conventional approaches.

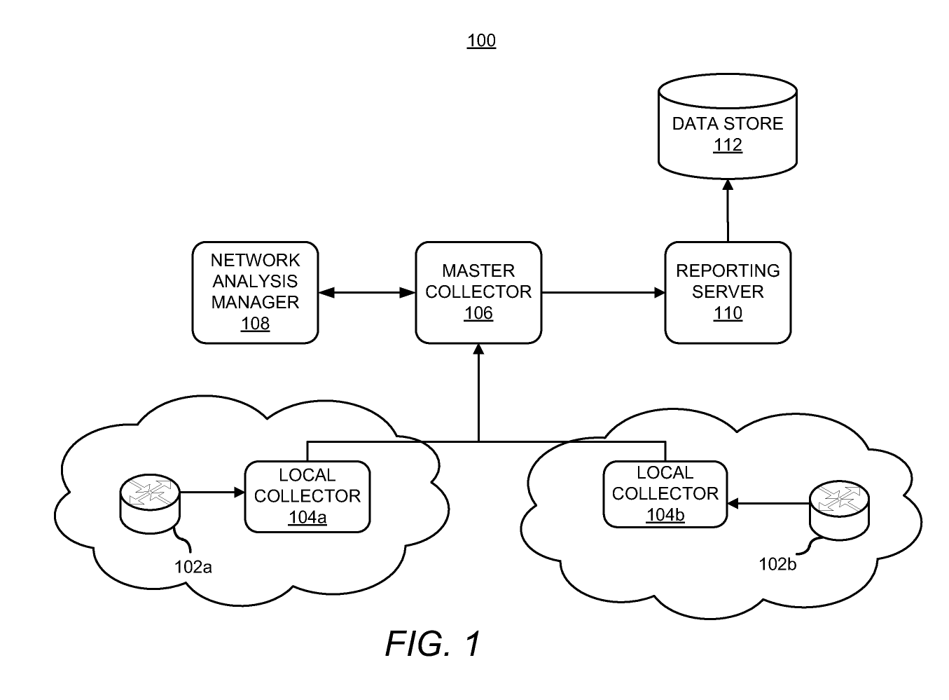

With reference first to FIG. 1, there is shown a diagram of a network 100, according to an example. The network 100 is depicted as having a plurality of routers 102a-102b, a plurality of local collectors 104a-104b, a master collector 106, a network analysis manager 108, a reporting server 110, and a data store 112. It should be clearly understood that the network 100 may include additional components and that some of the components described herein may be removed and/or modified without departing from a scope of the network. As such, the network 100 may include any number of switches, routers, uplinks, downlinks, source devices, and network devices.

There may be a plurality of virtual local area networks (VLANS) implemented in the network 100. The VLANs are primarily switch configuration items and route data packets through nodes in the network, such as the routers 102a-102b. The network 100 includes an IP flow collection framework through which packet flow information, for instance, Internet protocol (IP) information, containing information about IP flow in the network from the routers 102a-102b is aggregated and collected. The packet flow is an aggregation of data packets sent between the VLANs, for instance from a source VLAN to a destination VLAN. The IP flow collection framework of the network 100 includes a distributed architecture containing local collectors 104a-104b and the master collector 106. The local collectors 104a-104b receive, parse, filter and aggregate data packets from nodes (for instance, routers 102a-102b) in the network 100. The local collectors 104a-104b send aggregated IP flow information to the master collector 106, for instance, at a master node (not shown) that may be located within or outside of the network 100. The master collector 106 provides a network topology context for the collected packet flow information and may store the collected packet flow information, for instance, in the data store 112.

According to an example, the local collectors 104a-104b, the master collector 106, and the network analysis manager 108 each comprise machine readable instructions that may be stored, for instance, in a volatile or non-volatile memory, such as DRAM, EEPROM, MRAM, flash memory, floppy disk, a CD-ROM, a DVD-ROM, or other optical or magnetic media, and the like. The machine readable instructions may be stored in the memory, which are executable by a processor of a computing device. According to another example, each of the local collectors 104a-104b, the master collector 106, and the network analysis manager 108 comprise a hardware device, such as, a circuit or multiple circuits arranged on a board. According to a further example, the local collectors 104a-104b, the master collector 106, and the network analysis manager 108 each comprise a combination of modules with machine readable instructions and hardware modules. In addition, multiple processors may be employed to implement or execute the local collectors 104a-104b, the master collector 106, and the network analysis manager 108.

The local collectors 104a-104b may be implemented at each of the routers 102a-102b or switches at which a VLAN is implemented. The master collector 106 and the network analysis manager 108 may be located at any suitable server having access to the network 100. The local collectors 104a-104b may transfer the packet flow information to the master collector 106 at the master node using an access network or any wide area network (WAN) or other network. According to an example, the local collectors 104a-104b transform the packet flow information into a predetermined secure format and then transfers the packet flow information in the predetermined secure format to the master collector 106. In this example, the predetermined secure format comprises a format suitable for processing by the master collector 106.

The collected packet flow information may be input from the master collector 106 into a reporting subsystem at the reporting server 110 from which an external client may access information regarding the collected packet flow information. In the instance of inter VLAN traffic, the packet flow information contains the VLAN ID of a source VLAN of a router, for instance the router 102a, that receives the IP flow at ingress interfaces (not shown) of the router 102a. The packet flow information also contains the VLAN ID of a destination VLAN in the instance of IP flow reporting for IP flows sent from egress interfaces (not shown) of the router 102a to the destination VLAN. The local collectors 104a-104b parse the packet flow information and extract the VLAN ID and the router IP and interface indices along with other attributes of the flow such as source and destination addresses and ports, type of service, etc. This information is then aggregated over a configurable period and communicated to the master collector 106, for instance, in the predetermined secure format. By way of example, each IP flow may be aggregated over a predetermined time, for instance, over a period of minutes, before being communicated to the master collector 106.

The network analysis manager 108 performs network management including automatic discovery and network element and connection analysis to build a network topology, which provides a topological view of the network 100. The packet flow information reported by the routers 102a, 102b provides VLAN identifications (IDs). However, VLANs are substantially switch configuration items, and topological connectivity analysis is required for identification of the VLANs for which the packet flow information is being reported in the network topology. The network analysis manager 108 performs this topological connectivity analysis. An example of the network analysis manager 108 is the Network Node Manager (hereafter referred to as NNMi) from the Hewlett Packard Company. The network analysis manager 108 identifies VLANs and participating interfaces for the VLANs in the network 100 uniquely. In addition, in some instances, the network analysis manager 108 determines layer 2 and layer 3 views of the network 100 in the network topology. The network analysis manager 108 stores network and VLAN topology information that may be queried by external clients.

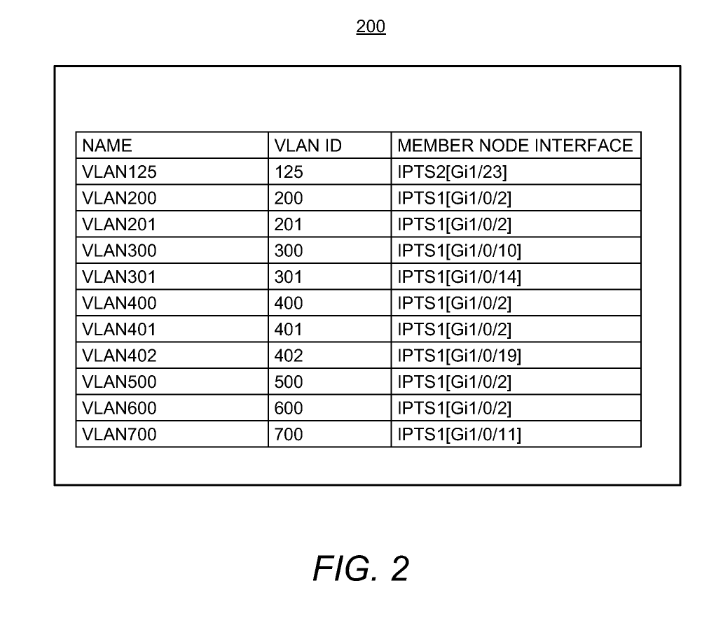

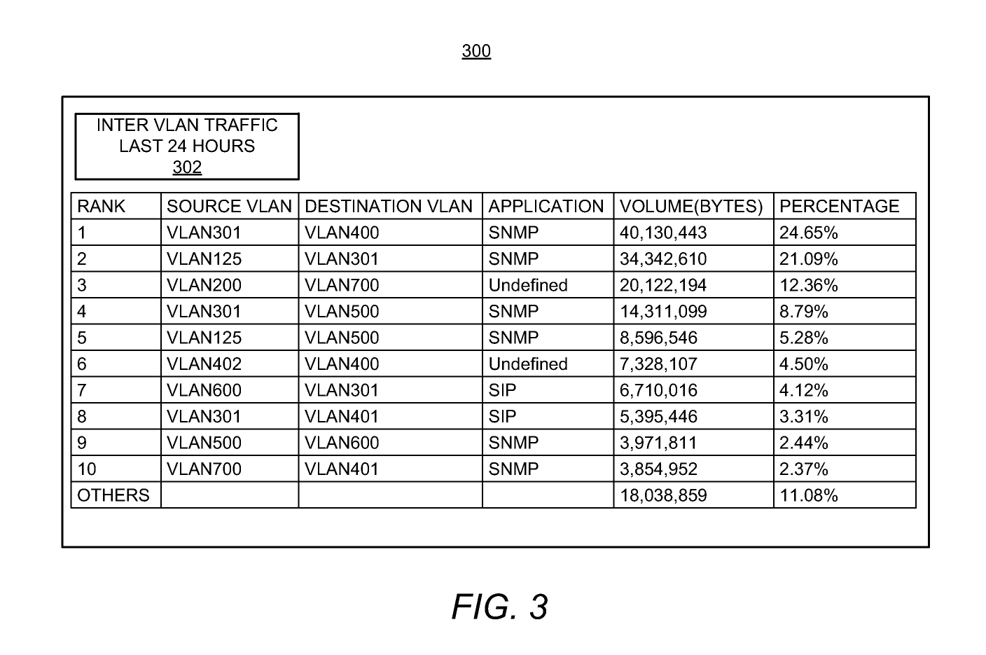

The master collector 106 may integrate with the network analysis manager 108, for instance, via a web-service software development kit (SDK), and for each packet flow information identify a corresponding VLAN instance in the network analysis manager 108. The master collector 106 determines a flow record for the IP data flow based on the VLAN topology information received from the network analysis manager 108. The flow records are stored in a database and made available to external clients via a rich reporting user interface, for instance as described hereinbelow with respect to FIG. 2 and FIG. 3.

With reference now to FIG. 2, there is shown a user interface 200 for a network analysis manager, for instance, the network analysis manager 108 depicted in FIG. 1, according to an example. It should be clearly understood that the user interface 200 may include additional components and that some of the components described herein may be removed and/or modified without departing from a scope of the user interface 200.

As shown in FIG. 2, VLANs discovered in the network topology and named in the network 100, for instance VLAN125 to VLAN700 are displayed in the user interface 200 of the network analysis manager 10. The named VLANs correspond to representations of the VLANs in the network topology determined by the network analysis manager 108. These representations of the VLANs include participating switches for each VLAN and interface details for switches and routers associated with each VLAN (not shown). The VLAN IDs of the VLANs in the network topology, as determined by the network analysis manager 108 using topology analysis, are also displayed, for instance, the VLAN IDs 125 to 700 in FIG. 2. The member node interfaces at which the VLANs are discovered, for instance, at the router 102a, identified in FIG. 2 as IPTS1 and the router 102b, identified in FIG. 2 as IPTS2, are shown with the corresponding name and VLAN ID.

With reference now to FIG. 3, there is shown a user interface 300 for a master collector, for instance, the master collector 106 depicted in FIG. 1, according to an example. It should be clearly understood that the user interface 300 may include additional components and that some of the components described herein may be removed and/or modified without departing from a scope of the user interface 300.

As shown in FIG. 3, an inter-VLAN traffic report 302 displays inter-VLAN traffic per application for each VLAN (for instance, VLAN301 as shown in FIG. 2). The inter-VLAN traffic report 302 may be determined for a configurable period, in this instance 24 hours. The inter-VLAN traffic may be ranked based on a total volume (in this instance in bytes) from each source VLAN to a destination VLAN for a particular application. The applications may include applications such as, but not limited to, simple network management protocol (SNMP), undefined applications, session initiation protocol (SIP), etc. For instance, as shown in FIG. 3, the IP flow for the 24 hour period from source VLAN301 to destination VLAN400 for SNMP is 40,130,443 bytes and 24.65% of a total inter-VLAN traffic determined for the 24 hour period.

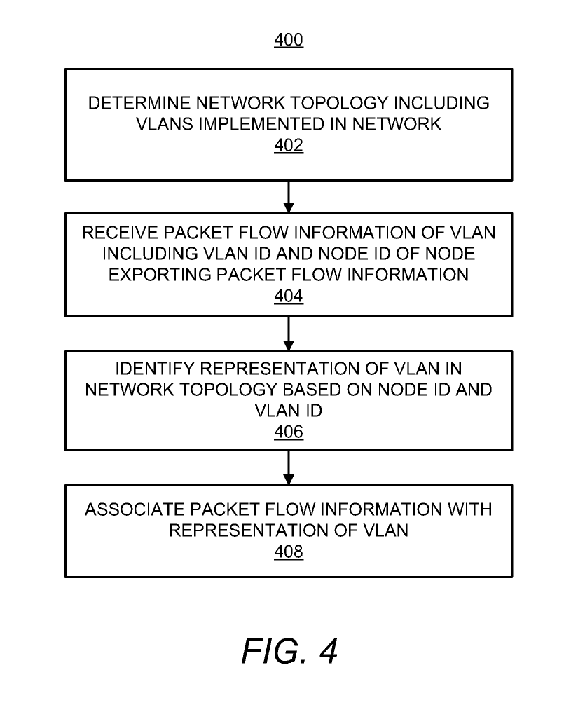

Various manners in which the local collectors 104a-104b, the master collector 106, and the network analysis manager 108 may operate are discussed with respect to the method 400 depicted in FIG. 4 and the diagram 400. It should be readily apparent that the method 400 depicted in FIG. 4 represents a generalized illustration and that other elements may be added or existing elements may be removed, modified or rearranged without departing from the scope of the method 400.

As shown in FIG. 4, there is shown a flow diagram of a method 400 analyzing a network, such as the network 100 depicted in FIG. 1, according to an example. It should be apparent that the method 500 represents a generalized illustration and that other processes may be added or existing processes may be removed, modified or rearranged without departing from a scope of the method 400.

At block 402, a topological analysis is performed to determine a network topology of the network 100 including VLANs implemented in the network 100, for instance, by the network analysis manager 108. The topological analysis may be performed for each packet flow information exporting node (for instance, the router 102a in FIG. 1) that the network analysis manager 108 may access.

According to an example, a determination of each switch connected to a node is made for each node at which the packet data flow is accessed. A further determination of a VLAN ID of each VLAN on the switch is made for each switch connected to the node. The network analysis manager 108 may thereby build a cache of all possible VLAN instances that are present on switches connected to the flow exporting node.

The topological analysis may be performed in the following manner to determine VLANs implemented in the network 100, for instance by the network analysis manager 108. The network analysis manager 108 may determine each flow exporting node, for instance, the routers 102a-102b in FIG. 1. The switches connected to the routers 102a-102b with VLANs discovered by the network analysis manager 108 may be determined. The VLAN ID for VLAN and the corresponding node may be stored in the network analysis manager 108. For all connected interfaces on the routers 102a-102b, the network analysis manager 108 may determine connection and the interface details for the other end of the connection. The VLAN ID and Internet Protocol (IP) index of the node and an interface index of the node may also be determined. The network analysis manager 108 retrieves representations of the VLANs (for instance using table 1 shown in FIG. 2) configured on the nodes hosting these (other end) interfaces and stores them based on the VLAN Id and the exporting router. As flow exporting nodes are identified the network analysis manager 108 augments the cache and the network topology. Thus for each flow record, the network analysis manager identifies each unique VLAN instance by network topology analysis.

At block 404, packet flow information of a VLAN is received, for instance by the master collector 106. The packet flow information is sent form a node in the network 100 and includes a VLAN identification (ID) of the VLAN. The packet flow information may be collected for a predefined time, for instance by the local collectors 104a-104b at the nodes, in this instance the routers 102a-102b.

The local collectors 104a-104b may determine the packet flow information by aggregating IP flow packets received from a router or multiple routers over a period of time and determining packet flow information based on the aggregated data packets. The local collectors 104a-104b may output the packet flow information to the master collector 106 as described hereinabove with respect to FIG. 1.

At block 406, a representation of the VLAN, for instance in the network topology, is identified based on the node and the VLAN ID of the VLAN. For example, in an instance in which packet flow information is received by the master collector 106, the master collector 106 may use the VLAN ID and an identification of the node, for instance a router IP address for the router 102a, to determine a corresponding singular VLAN instance. For instance, the master collector 106 may use a table similar to that shown on the user interface 300 in FIG. 3 to identify a representation of the VLAN based on the node and the VLAN ID of the VLAN.

At block 408, the packet flow information is associated with the representation of the VLAN, for instance by the master collector 106. The packet flow information may be populated in a flow record and stored in the data store 112. The master collector 106 may store the packet flow information and the associated representation of the VLAN and/or reporting the packet flow information and the associated representation of the VLAN to an external client.

Some or all of the operations set forth in the method 400 may be contained as a utility, program, or subprogram, in any desired computer accessible medium. In addition, the method 400 may be embodied by computer programs, which can exist in a variety of forms both active and inactive. For example, they may exist as machine readable instructions, including source code, object code, executable code or other formats. Any of the above may be embodied on a computer readable storage medium.

Exemplary computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

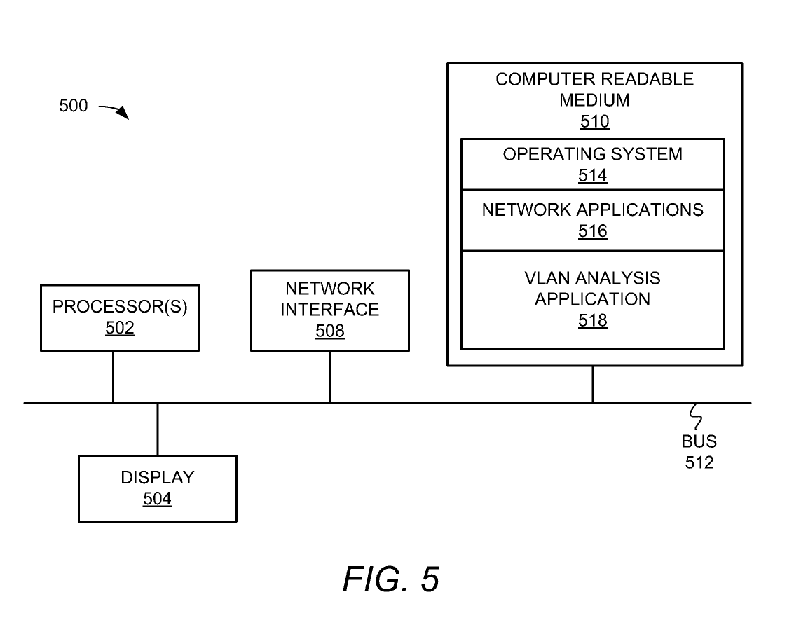

Turning now to FIG. 5, there is shown a schematic representation of a computing device 500 configured in accordance with examples of the present disclosure. The device 500 includes a processor 502, such as a central processing unit; a display device 504, such as a monitor; a network interface 508, such as a Local Area Network LAN, a wireless 802.11x LAN, a 3G mobile WAN or a WiMax WAN; and a computer-readable medium 510. Each of these components is operatively coupled to a bus 512. For example, the bus 512 may be an EISA, a PCI, a USB, a FireWire, a NuBus, or a PDS.

The computer readable medium 510 may be any suitable medium that participates in providing instructions to the processor 502 for execution. For example, the computer readable medium 510 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 510 may also store other machine readable instructions, including word processors, browsers, email, Instant Messaging, media players, and telephony machine-readable instructions.

The computer-readable medium 510 may also store an operating system 514, such as Mac OS, MS Windows, Unix, or Linux; network applications 516; and a VLAN analysis application 518. The operating system 514 may be multi-user, multiprocessing, multitasking, multithreading, real-time and the like. The operating system 514 may also perform basic tasks such as recognizing input from input devices, such as a keyboard or a keypad; sending output to the display 504; keeping track of files and directories on the computer readable medium 510; controlling peripheral devices, such as disk drives, printers, image capture device; and managing traffic on the bus 512. The network applications 516 include various components for establishing and maintaining network connections, such as machine readable instructions for implementing communication protocols including TCP/IP, HTTP, Ethernet, USB, and FireWire.

The VLAN analysis application 518 provides various components for managing data traffic a network in which VLANs are implemented, as described above. In certain examples, some or all of the processes performed by the application 518 may be integrated into the operating system 514. In certain examples, the processes may be at least partially implemented in digital electronic circuitry, or in computer hardware, machine readable instructions (including firmware and/or software), or in any combination thereof.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein is a preferred example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for analyzing a network, said method comprising:
receiving packet flow information of a virtual local area network (VLAN) implemented in the network, wherein the packet flow information is sent from a node in the network and includes a VLAN identification (ID) of the VLAN;
identifying a representation of the VLAN in a network topology based on the node and the VLAN ID of the VLAN; and
associating, by a processor, the packet flow information with the representation of the VLAN.

2. The method according to claim 1, wherein the packet flow information of the VLAN further includes an application, a packet volume and a type of service associated with the VLAN; and
wherein associating the packet flow information with the representation of the VLAN comprises associating the application, the packet volume and the type of service with the representation of the VLAN.

3. The method according to claim 1, further comprising:
performing a topological analysis to determine the representation of the VLAN in the network topology, wherein the representation of the VLAN includes participating switches in the VLAN.

4. The method according to claim 1, further comprising:
performing a topological analysis to determine the network topology.

5. The method according to claim 4, wherein performing the topological analysis to determine the network topology further comprises:
determining, for each node from which the packet data information is sent, each switch connected to the node.

6. The method according to claim 5, further comprising:
determining for each switch connected to each node, a VLAN ID of each VLAN on the switch.

7. The method according to claim 1, wherein identifying the representation of the VLAN in the network topology based on the node and the VLAN ID of the VLAN further comprises:
identifying the representation of the VLAN based on an Internet protocol (IP) index of the node and an interface index of the VLAN on the node.

8. The method according to claim 1, wherein the VLAN comprises one of a source VLAN and a destination VLAN.

9. The method according to claim 1, further comprising:
one of storing the packet flow information and the associated representation of the VLAN and reporting the packet flow information and the associated representation of the VLAN.

10. The method according to claim 1, wherein receiving packet flow information of the VLAN further comprises:
determining packet flow information at the node in the network;
aggregating the packet flow information; and
transmitting the packet flow information to a master node in the network.

11. An apparatus for analyzing a network, the apparatus comprising:
a module to receive packet flow information of a virtual local area network (VLAN) implemented in the network, wherein the packet flow information sent from a node in the network includes a VLAN identification (ID) of the VLAN, identify a representation of the VLAN in a network topology based on the node and the VLAN ID of the VLAN, and associate the packet flow information with the representation of the VLAN; and
a processor to implement the module.

12. The apparatus according to claim 11, wherein the packet flow information of the VLAN further comprises an application, a packet volume and a type of service associated with the VLAN, and wherein, to associate the packet flow information with the representation of the VLAN, the module associates the application, the packet volume and the type of service with the representation of the VLAN.

13. The apparatus according to claim 11, wherein the module performs a topological analysis to determine the representation of the VLAN in the network topology, wherein the representation of the VLAN includes participating switches in the VLAN.

14. The apparatus according to claim 11, wherein the module further performs a topological analysis to determine the network topology.

15. The apparatus according to claim 14, wherein to perform the topological analysis to determine the network topology, the module determines, for each node from which the packet flow information is sent, each switch connected to the node.

16. The apparatus according to claim 15, wherein the module determines for each switch connected to each node, a VLAN ID of each VLAN on the switch.

17. The apparatus according to claim 11, wherein the module stores the packet flow information and the associated representation of the VLAN or reports the packet flow information and the associated representation of the VLAN.

18. A system for analyzing a network, the system comprising:
a local collector to receive packet flow information for a virtual local area network (VLAN) implemented in the network, wherein the packet flow information is sent from a node in the network and includes a VLAN identification (ID) of the VLAN, to aggregate the packet flow information and to output the aggregated packet flow information;
a master collector to receive the aggregated packet flow information, identify a representation of the VLAN in a network topology based on the node and the VLAN ID of the VLAN, and associate the packet flow information with the representation of the VLAN; and
a processor to implement the local collector and the master collector.

19. The system according to claim 18, further comprising:
a network analysis manager to perform a topological analysis to determine the representation of the VLAN in the network topology, wherein the representation of the VLAN includes participating switches in the VLAN.

20. A computer readable storage medium on which is embedded a computer program, said computer program implementing a method for analyzing a network, said computer program comprising computer readable code to:
receive packet flow information of a virtual local area network (VLAN) implemented in the network, wherein the packet flow information is sent from a node in the network and includes a VLAN identification (ID) of the VLAN;
identify a representation of the VLAN in a network topology based on the node and the VLAN ID of the VLAN; and
associate the packet flow information with the representation of the VLAN.
